(19) United States
(12) Patent Application Publication
(10) Pub. No.: US 2009/0292585 A1
(43) Pub. Date: Nov. 26, 2009

(54) METHOD FOR ONLINE SELLING AND MANAGING UNITEDLY BY FRANCHISE'S PARTICIPATION OF PARTIAL RESPONSIBILITY

(76) Inventor: Yong Sung Seo, Chungchungnam-do (KR)

Correspondence Address: THE RAFFERTY PATENT LAW FIRM, 1952 Gallows Road, Suite 200, Vienna, VA, 22182-3823, US

(21) Appl. No.: 12/304,756

(22) PCT Filed: Jun. 12, 2007
(86) PCT No.: PCT/KR07/02814

§ 371 Date: Jul. 6, 2009

(30) Foreign Application Priority Data
Jun. 12, 2006 (KR) 10-2006-0052625
Feb. 8, 2007 (KR) 10-2007-0013050

(51) Int. Cl. G06Q 30/00; G06Q 10/00; G06F 15/16; G06Q 50/00

(52) U.S. Cl. 705/10; 705/14.27; 705/26; 705/28; 705/29; 705/30; 709/204

(57) ABSTRACT

In a hot chamber die casting apparatus of pressurizing molten magnesium alloy at an atmospheric pressure or higher without being exposed to the atmosphere and forming a magnesium alloy casting product in the shape of a mold, the hot chamber die casting apparatus basically configured with a melting furnace having a heater, a pressure unit configured to pressurize the molten magnesium alloy, and a mold configured to shape a product, and includes an electromagnetic stirrer disposed around a nozzle between a pressure chamber and the mold, and configured to stir semisolid magnesium alloy, the pressure chamber being connected to the melting furnace and supplying magnesium alloy in liquid state, wherein an inner diameter of the nozzle is partially or wholly smaller than that of the pressure chamber so as to crush solid phases existing in the semisolid magnesium alloy in the pressure chamber or the nozzle.

### TECHNICAL FIELD

The present invention relates to a method for online selling and managing unitedly by franchise's participation of partial responsibility, in which a head office administrating a shopping mall registers a customer as a purchase member under management of a franchise or designates a franchise in charge of the purchase member through a request of the purchase member. In the method, when the customer places an order for a product on line, the order is automatically received by the franchise in charge of the customer such that the franchise can provide various and convenient services to the customer.

### BACKGROUND ART

As the information and communication technology develops and the Internet is commonly used, a general purchase system is implemented into a purchase management system using the Internet. For example, people purchase commodities through a shopping mall or books through an Internet bookstore. However, an operating body administrating the shopping mall is in charge of all services such as order reception, delivery, customer service and the like. Therefore, only manufactured goods which have nothing to do with a delivery period can be transacted. Further, the reliability and the convenience of payment decrease, which are advantages of an off-line shopping mall. In addition, even when a company having agencies administers a shopping mall, a head office of the company receives an order and then gives an agency a delivery instruction.

When companies purchase maintenance repair and operating materials, a purchase system using the Internet needs to be introduced. However, the use of such a system has yet activated.

To be equipped with competitiveness through the reduction in purchase cost by accurately purchasing necessary Maintenance Repair and Operating (MRO) materials, companies need to introduce such a purchase system. In particular, small and medium-sized companies, which cannot purchase and manage maintenance repair and operating materials used in the field at a proper time, urgently need such a standardization system for purchase management. In the purchase management of maintenance repair and operating materials, industrial materials used in each small and medium-sized company are required. The industrial materials are so complex as not to be classified into common materials. Therefore, it is not easy to implement a general standardization system.

In a conventional supply method, MRO materials are supplied on the offline, and it is difficult for most of companies to share the kinds and standards of products, which are not widely used. Further, while a customer places an order through a telephone or facsimile and a company manages the order, communication therebetween may not be performed smoothly, so that an error frequently occurs in the method.

Recently, large-sized companies construct MRO sites and serve as a purchase agent for MRO materials. However, the companies induce only their affiliated companies or subcontract companies to use the MRO sites as a supply window of MRO materials. Therefore, it is difficult for general small and medium-sized companies to use the MRO sites in terms of the price, the appointed date, and the convenience.

Further, when a product supply contract is closed through an electronic auction bid, the continuous supply of products is not guaranteed. Because of excessive competition for product sale, profitability decreases.

In addition, since a supplier does not store various products in a limited warehouse, the diversity of purchase decreases. When an ordered product is out of stock, the appointed date for the product is delayed.

In some cases, while products which should be received daily or periodically in a house or products of which the freshness should be maintained are ordered through a uniform selection method of suppliers, the inconvenience of customers continuously occurs, because a function of selecting periods desired by the customers is not provided.

### DISCLOSURE OF INVENTION

### Technical Problem

An advantage of the invention is that it provides a method for online selling and managing unitedly by franchise's participation of partial responsibility, in which a head office administrating a shopping mall on line registers a customer as a purchase member under management of a franchise or designates a franchise in charge of a purchase member through a request of the purchase member. In the method, each franchise stores only common materials of which the turnover rates are high, and the head office commonly stores specific materials of which the turnover rates are low. Therefore, it is possible to accurately and quickly provide various products to the customers, even though the minimum area is provided for the management of products. Another advantage of the invention is that it provides a method for online selling and managing unitedly by franchise's participation of partial responsibility, in which monthly regular payment is carried out through a contract such that purchase determination is rapidly achieved, the purchase rating of each customer is set to apply a differentiated price such that a customer-oriented service is achieved, and each franchise manages its customers, delivers ordered products, and makes request for securing the stock through on-line menus provided by the head office.

### Technical Solution

According to an aspect of the present invention, a method for online selling and managing unitedly by franchise's participation of partial responsibility comprises: at a central management server, receiving predetermined information on a new customer from a franchise terminal or customer terminal so as to receive a membership registration request (step 100); at the central management server, determining the purchase rating of the customer, registering the customer as a member, and granting a unique code to the customer (step 200); at the central management server, performing user authentication as the customer terminal requests connection, and then providing information on products, stored by a head office and nationwide franchises, to the customer terminal (step 300); at the central management server, when an order request for a product is made from the customer terminal, noticing the breakdown of the order request to a franchise in charge of the customer by using a wired and wireless communication network (step 400); and at the central management server, when a product delivery request is made from the franchise terminal, giving an instruction to deliver the requested product (step 500).

Preferably, the purchase rating is periodically updated by reflecting the credit, the transaction volume, and the integration degree for a single item of the customer.

Preferably, the product information includes the price of the product, and the price of the product is differentially determined for each customer, depending on a discount rate according to the purchase rating of the customer.

The method further comprises the step of, at the central management server, when the payment of the customer is performed through cash payment or regular payment, checking if an adjusted amount is received from the franchise in charge of the customer, and noticing the result to the franchise terminal (step 600).

The method further comprises the step of, at the central management server, when the payment of the customer is performed through credit-card payment, receiving the breakdown of the credit-card payment by the customer from a credit card company, and noticing the breakdown of the credit-card payment and the adjusted breakdown of the payment to the franchise terminal (step 700).

Preferably, step 200 includes: at the central management server, verifying the customer who has requested the membership registration, registering the customer as a member when the customer has no reason for disqualification, and determining the purchase rating of the customer by reflecting the received predetermined information on the customer (step 210); at the central management server, designating a franchise in charge of the registered customer, granting a unique code to the customer, and storing the information on the customer, the unique code, and information on the franchise in charge of the customer into a database (step 220); and at the central management server, noticing the unique code, granted to the customer, to the franchise terminal of the franchise in charge of the customer (step 230).

Preferably, step 400 includes: at the central management server, providing a customer interface screen, through which a product order is placed, to the customer terminal (step 410); and at the central management server, when an order request for a product is made from the customer terminal, noticing the breakdown of the order request to the franchise in charge through the wired and wireless communication network (step 420).

Preferably, the customer interface screen includes a menu for inputting an order request for a product and a purchase period such that the order request is automatically made at every the purchase period and a menu for checking the breakdown of the previous order for each day and each item and the payment breakdown.

As for the wireless and wired communication, an email, a mobile-phone text message, an automatic phone using Computer Telephony Integration (CTI) and the like are used.

Preferably, when the franchise terminal requests connection to the central management server at steps 100 and 500, the central management server performs user authentication and then provides a franchise manager screen to the franchise terminal, the franchise manager screen including a menu for providing information on each customer under management of the franchise, the present status of product order from each customer, the present status of products stored by the head office, the present status of products stored by each franchise and the like, and a menu for selecting the type of product delivery by discriminating whether the ordered product is directly delivered to the customer from the head office or is delivered to the corresponding franchise.

Preferably, when a product delivery request is made from the franchise terminal through the franchise manager terminal at step 500, the central management server gives an instruction to deliver a requested product by discriminating whether the product is delivered to the customer or the franchise in charge.

Preferably, the franchise manager screen includes a menu for checking and managing a list of warehoused products, a quantity of warehoused products, a list of shipped products, a quantity of shipped products, and a list of stored products in the corresponding franchise and a menu for providing the present status of unattended transactions caused by insufficient quantities in stock.

Preferably, when the head office does not store a product which is to be delivered to the customer or the franchise, the central management server makes a product delivery request to a franchise, which stores the corresponding product, among the nationwide franchises.

According to another aspect of the invention, a method for online selling and managing unitedly by franchise's participation of partial responsibility comprises: (a) at a central management server, receiving predetermined information on a new customer from a franchise terminal so as to receive a membership registration request; (b) at the central management server, designating the franchise, which has requested membership registration, as a franchise in charge of the customer, registering the customer as a member with a predetermined purchase rating, and granting a unique code to the customer; (c) at the central management server, performing user authentication as a customer terminal requests connection, and then providing information on products, stored by a head office and nationwide franchises, to the customer terminal; (d) at the central management server, when an order request for a product is made from the customer terminal, registering the breakdown of the order request into a franchise manager region of the central management server in real time; (e) at the franchise terminal connected to the central management server, checking the breakdown of the order request through a franchise manager screen so as to make a delivery request for the product; (f) at the central management server, giving an instruction to deliver the ordered product; and (g) at the customer terminal, making payment for the ordered product.

Preferably, the purchase rating is periodically updated by reflecting the credit, the transaction volume, and the integration degree for a single item of the customer.

Preferably, the product information includes the price of the product, and the price of the product is differentially determined for each customer, depending on a discount rate according to the purchase rating of the customer.

The method further comprises the step of, at the central management server, when the payment of the customer is performed through cash payment or regular payment, checking if an adjusted amount is received from the franchise in charge of the customer, and noticing the result to the franchise terminal.

The method further comprises the step of, at the central management server, when the payment of the customer is performed through credit-card payment, receiving the breakdown of the credit-card payment by the customer from a credit card company, and noticing the breakdown of the credit-card payment and the adjusted breakdown of the payment to the franchise terminal.

Preferably, step (b) includes: (b-1) at the central management server, verifying the customer who has requested the membership registration, registering the customer as a member when the customer has no reason for disqualification, and determining the purchase rating of the customer by reflecting the received predetermined information on the customer; (b-2) at the central management server, designating a franchise in charge of the registered customer, granting a unique code to the customer, and storing the information on the customer, the unique code, and information on the franchise in charge of the customer into a database; and (b-3) at the central management server, noticing the unique code, granted to the customer, to the franchise terminal of the franchise in charge of the customer.

Preferably, step (d) includes: (d-1) at the central management server, providing a customer interface screen, through which a product order is placed, to the customer terminal; and (d-2) at the central management server, when a order request for a product is made from the customer terminal, registering the breakdown of the order request into the franchise manager region of the central management server in real time.

Preferably, the customer interface screen includes a menu for inputting an order request for a product and a purchase period such that the order request is automatically made at every the purchase period and a menu for checking the breakdown of the previous order for each day and each item and the payment breakdown.

Preferably, the customer interface screen provides a menu for inputting an order date for a product when the product is selected by an external input unit.

Preferably, the customer interface screen provides a menu for inputting an order date for a product when the product is selected by an external input unit.

Preferably, the customer interface screen displays the price of each product which is automatically varied depending on a discount or extra rate which is separately set for each franchise selling the product.

Preferably, the customer interface screen provides a menu for designating options of various products on one screen and then performing selection for an order.

Preferably, the customer interface screen displays the total price of products, selected for an order, on a specific region within the customer interface screen in real time.

Preferably, when the franchise terminal requests connection to the central management server at steps (a) and (e), the central management server performs user authentication and then provides a franchise manager screen to the franchise terminal, the franchise manager screen including a menu for providing information on each customer under management of the franchise, the present status of product order from each customer, the present status of products stored by the head office, the present status of products stored by each franchise and the like, and a menu for selecting the type of product delivery by discriminating whether the ordered product is directly delivered to the customer from the head office or is delivered to the corresponding franchise.

Preferably, when a product delivery request is received from the franchise terminal through the franchise manager terminal at step (e), the central management server gives an instruction to deliver the requested product by discriminating whether the product is directly delivered to the customer or is delivered to the franchise in charge.

Preferably, the franchise manager screen includes a menu for checking and managing a list of warehoused products, a quantity of warehoused products, a list of shipped products, a quantity of shipped products, and a list of stored products in the corresponding franchise and a menu for providing the present status of unattended transactions caused by insufficient quantities in stock.

Preferably, the franchise manager screen displays the image of a specific product on a pop-up window, when the product is selected from a product list by the external input unit.

Preferably, when the head office does not store the ordered product at step (f), the central management server makes a product delivery request to a franchise, which stores the corresponding product, among the nationwide franchises.

### ADVANTAGEOUS EFFECTS

According to the present invention, each franchise manages its customers and is responsible for the payment of the customers. The franchise does not serve as a simple manager of the service provided by the head office, but serve as an operating body participating in the business. Therefore, the franchise can make profits as an operating body. Each franchise stores only common materials of which the turnover rates are high, and the head office commonly stores specific materials of which the turnover rates are low. Therefore, it is possible to accurately and quickly provide various products to the customers, even though the minimum area is provided for the management of products. Further, the price is differentially applied to each customer such that a customer-oriented service can be implemented.

### BRIEF DESCRIPTION OF THE DRAWINGS

FIG. 1 is a diagram showing the configuration of a system for explaining a method for online selling and managing unitedly by franchise's participation of partial responsibility according to an embodiment of the invention.

FIG. 2 is a flow chart for explaining a method for online selling and managing unitedly by franchise's participation of partial responsibility according to a first embodiment of the invention.

FIG. 3 is a flow chart for explaining a process of step S200 in the method for online selling and managing unitedly by franchise's participation of partial responsibility according to the first embodiment of the invention.

FIG. 4 is a flow chart for explaining a process of step S400 in the method for online selling and managing unitedly by franchise's participation of partial responsibility according to the first embodiment of the invention.

FIG. 5 is a diagram showing an initial screen in the method for online selling and managing unitedly by franchise's participation of partial responsibility according to the first embodiment of the invention.

FIG. 6 is a diagram showing a customer interface screen in the method for online selling and managing unitedly by franchise's participation of partial responsibility according to the first embodiment of the invention.

FIG. 7 is a diagram showing components of a franchise manager screen in the method for online selling and managing unitedly by franchise's participation of partial responsibility according to the first embodiment of the invention.

FIG. 8 is a diagram showing components of a central-management-server manager screen in the method for online selling and managing unitedly by franchise's participation of partial responsibility according to the first embodiment of the invention.

FIG. 9 is a flow chart for explaining a method for online selling and managing unitedly by franchise's participation of partial responsibility according to an embodiment of the invention according to a second embodiment of the invention.

FIG. 10 is a flow chart for explaining a process of step S20 in the method for online selling and managing unitedly by franchise's participation of partial responsibility according to the second embodiment of the invention.

FIG. 11 is a flow chart for explaining a process of step S40 in the method for online selling and managing unitedly by franchise's participation of partial responsibility according to the second embodiment of the invention.

FIG. 12 is a diagram showing an initial screen in the method for online selling and managing unitedly by franchise's participation of partial responsibility according to the second embodiment of the invention.

FIG. 13 is a diagram showing a customer interface screen in the method for online selling and managing unitedly by franchise's participation of partial responsibility according to the second embodiment of the invention.

FIG. 14 is a diagram showing a portion of the customer interface screen in the method for online selling and managing unitedly by franchise's participation of partial responsibility according to the second embodiment of the invention.

FIG. 15 is a diagram showing a portion of the customer interface screen in the method for online selling and managing unitedly by franchise's participation of partial responsibility according to the second embodiment of the invention.

### BEST MODE FOR CARRYING OUT THE INVENTION

Hereinafter, a method for online selling and managing unitedly by franchise's participation of partial responsibility according to an embodiment of the invention will be described with reference to the accompanying drawings.

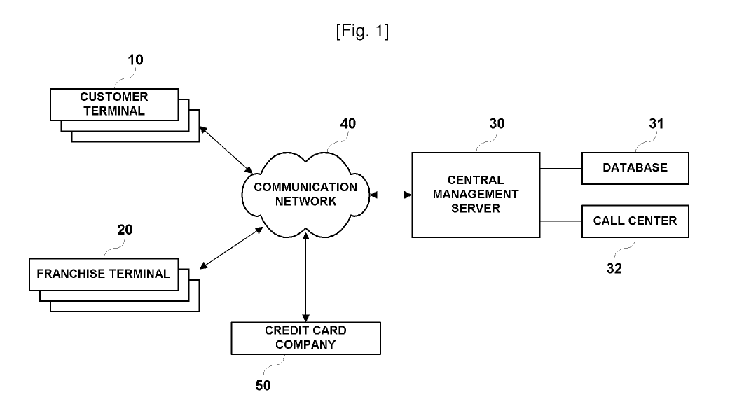

FIG. 1 is a diagram showing the configuration of a system for explaining a method for online selling and managing unitedly by franchise's participation of partial responsibility according to an embodiment of the invention.

A customer terminal 10 serves as an interface through which a customer who has been registered as a member through a franchise is connected to a central management server 30 of a head office providing a service so as to use the service. For example, the customer checks a product which the customer is to purchase and places an order for the product.

A franchise terminal 20 serves as an interface through which a franchise is connected to the central management server 30. Through the franchise terminal 20, the franchise checks the present status of product orders from membership customers under its management, gives delivery instructions in accordance with the product orders of the customers, and requests the head office to deliver products in stock.

The central management server 30 is a unit used when the head office provides a service to the customer terminal 10 and the franchise terminal 20 through a communication network 40. The central management server 30 provides product information to the customer terminal 10 and receives a product order request. Further, when the central management server 30 receives a product delivery request from the franchise terminal 20, it gives an instruction to deliver a product to the corresponding destination.

A database 31 serves to store information on membership customers and franchises. More specifically, the database 31 stores information, such as the credit, the transaction volume, the integration degree for a single item of each customer, and the purchase rating and discount rate of each customer.

When a consultation request for a product or the service is made from the customer terminal 10, a call center 32 provides detailed information with respect to the consultation request, in accordance with an instruction of the central management server 30.

A communication network 40 serves to connect the central management server 30 of the head office to a plurality of customer terminals 10 and a plurality of franchise terminals 20. In general, the communication network 40 is referred to as the wireless and wired Internet.

When credit-card payment is carried out by the request of a customer, a card company server 50 informs the central management server 30 of the breakdown of the credit-card payment.

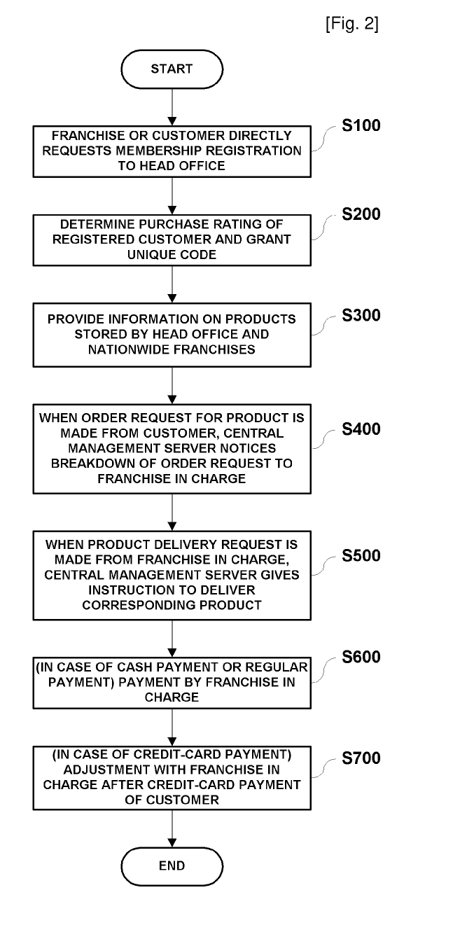

FIG. 2 is a flow chart showing a method for online selling and managing unitedly by franchise's participation of partial responsibility according to a first embodiment of the invention.

As shown in FIG. 1, the central management server 30 receives predetermined information on a new customer from the franchise terminal 20 or the customer terminal 10 so as to receive a membership registration request (step S100). In this case, the franchise corresponds to a franchise which has already had a license contract with the head office on the offline. When a franchise makes a contract to participate in a business provided by the head office on the offline, the franchise is not a simply service subscriber, but serves as an operating body which manages the business with the head office. The franchise can carry on business in a region to which it belongs, with respect to a buyer which wants to purchase MRO materials. To use the service provided by the head office, the corresponding buyer must join the membership of the head office. The franchise, which is responsible for transaction with the buyer, first verifies the stability of the transaction, and then makes request for membership registration such that the corresponding buyer can become a customer of the head office.

Further, the buyer can be directly connected to the central management server 30 of the head office so as to request the membership registration. In this case, since a franchise which manages the buyer does not exist, the head office designates a franchise in charge when the buyer is registered. In general, a franchise in charge of the region to which the buyer belongs is designated as the franchise in charge.

Subsequently, the central management server 30 determines the purchase rating of the customer, registers the customer as a member, and grants a unique code to the customer (step S200).

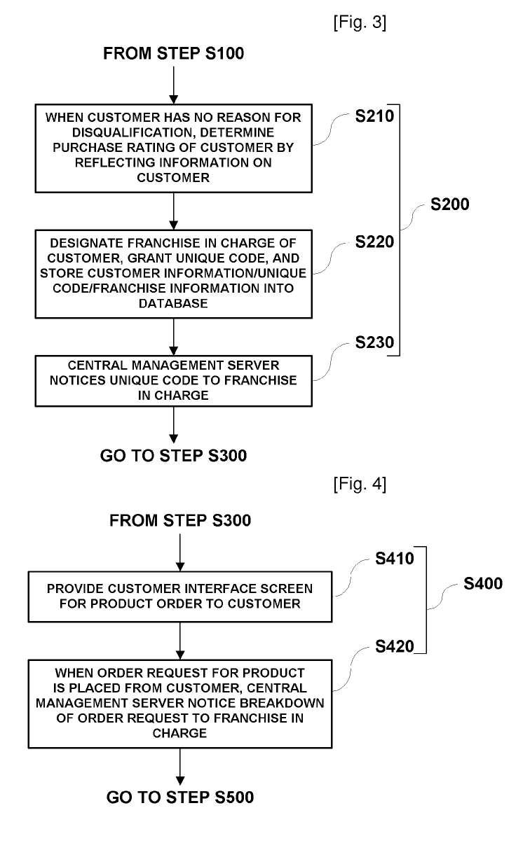

Referring to FIG. 3, the process of step S200 in the method for online selling and managing unitedly by franchise's participation of partial responsibility will be described in more detail.

As shown in FIG. 3, the central management server 30 verifies the customer who has request the membership registration. When the customer has no reason for disqualification, the central management server 30 registers the customer as a member and determines the purchase rating of the customer by reflecting predetermined information on the customer (S210). Here, the purchase rating is periodically updated by reflecting the credit, the transaction volume, and the integration degree for a single item of the customer, even after the purchase rating is set.

According to the invention, a discount rate is applied in accordance with the purchase rating of each customer such that the price can be discriminated. The standards for determining the purchase rating of each customer includes the credit, the transaction volume, and the integration degree for a single item of the customer. Therefore, when a customer joins the membership for the first time, a discount rate for product price is not applied. However, while the credit of the customer gradually increases and other transaction information is accumulated, the discount rate of the customer changes depending on a change in purchase rating. For example, when the credit of the customer decreases, the discount rate of the customer decreases. On the contrary, when the credit of the customer increases, the discount rate of the customer also increases. As such, the discount rate of a customer is determined depending on the purchase rating of the customer and is stored in the database 31. The update period for the credit, the transaction volume, and the integration degree for a single item of each customer can be arbitrarily set. Generally, they are updated every three months.

Next, the central management server 30 designates a franchise which is to be in charge of the customer who has joined the membership, grants a unique code to the customer, and stores the information and unique code of the customer and the information of the franchise in charge of the customer into the database (step S220). At this time, when the membership registration request is received by the franchise terminal 20, the customer is registered as a member who is to be managed by the franchise which has requested the membership registration. When the customer directly requests the membership registration, the customer is registered as a member who is to be managed by a franchise designated by the head office.

Subsequently, the central management server 30 notice the unique code, granted to the customer, to the franchise terminal 20 (step S230). Then, the franchise receiving the unique code of the customer individually informs the customer of the unique code, thereby notifying that the customer has been registered as a member of the head office. After that, the customer can start transactions using the service provided by the head office.

Next, as the customer terminal 10 requests connection the central management server 30 performs user authentication. Then, the central management server 30 provides information on products, stored by the head office and nationwide franchises, to the customer terminal 10 (step S300). The product information includes the price of each product, and the price of each product is differentially provided to each customer, depending on the discount rate according to the purchase rating of the customer. That is, the product information provided to the customer connected to the central management server 30 is not limited to information on the products stored by the head office, but includes information on the overall products stored by all the franchises which have joined the service. At this time, when the credit of the customer decreases below a predetermined level because the payment of the customer is delayed, the central management server 30 does not provide the product information and the price of each product to the corresponding customer any more.

Next, when an order request for a product is made from the customer terminal 10, the central management server 30 notices the breakdown of the order request to the franchise in charge by using the wireless and wired communication network (step S400).

Referring to FIG. 4, the process of step S400 in the method for online selling and managing unitedly by franchise's participation of partial responsibility will be described in more detail.

First, the central management server 30 provides to the customer terminal 10 a customer interface screen through which a product order can be input (step S410).

At this time, when an order for a product is input from the customer terminal 10, the customer interface screen provides a menu for selecting a purchase period in such a manner that the order for the corresponding product is automatically placed at the purchase period. Therefore, as the customer selects a predetermined purchase period (3, 6, or 12 months), an order for a product which should be periodically purchased can be placed in advance.

Further, the customer interface screen provides such menus that the customer can checks the breakdown of the previous order for each day and each product and the breakdown of the payment.

In addition, when a consultation request signal is received from the customer terminal 10, the central management server 30 connects the customer terminal 10 through wireless and wired communication to the call center 32 which provides consultation information. That is, the customer can request a consultation about all products, provided through the service of the head office, by using a call center service provided by the head office. Further, the customer can receive the detail descriptions of the product, about which the customer requested a consultation, and the information on the product.

Next, when an order request for a product is made from the customer terminal 10, the central management server 30 notices the breakdown of the order request to the franchise in charge through the wireless and wired communication network (step S420).

That is, after reviewing the product information provided by the central management server 30, the customer can place an order for a product through the central management server 30 of the head office connected through the communication network 40. At this time, products which can be ordered by the customer are not limited to the products stored by the head office, but include the overall products stored by all the franchises which have joined the service of the head office. When the order is received from the customer, the central management server 30 informs the franchise, which manages the customer, that the customer has ordered the product. As for the wireless and wired communication, an email, a mobile-phone text message, an automatic phone using Computer Telephony Integration (CTI) and the like are used.

Subsequently, when a product delivery request is made from the franchise terminal 20, the central management server 30 gives an instruction to deliver a requested product (step S500). That is, the delivery instruction for the product which the customer has ordered is made through the franchise terminal 20 by the determination of the franchise which manages the customer.

At this time, when the franchise terminal 20 requests connection to the central management server 30 at steps S100 and S500, the central management server 30 performs user authentication and then provides a franchise manager screen to the corresponding franchise terminal 20. The franchise manager screen includes a menu for providing information on each customer under management of the franchise, the present status of product order of each customer, the present status of products stored by the head office, the present status of products stored by each franchise and the like, and a menu for selecting the type of product delivery by discriminating whether the ordered product is directly delivered to the customer from the head office and is delivered to the corresponding franchise.

That is, the final decision for the delivering of the ordered product to the customer is made by the selection of the franchise in charge of the corresponding customer. In this case, when the franchise does not have the product in stock, it can select the type of the product delivery through the franchise manager screen such that the product can be directly delivered to the customer from the head office. When the franchise has the product in stock, the franchise can directly deliver the product to the customer, which is optional. Therefore, the delivery can be more effectively achieved depending on the selection of the franchise. If necessary, the franchise may first receive the product and then deliver the product to the customer. In this case, the franchise can select the type of the product delivery such that the product is first delivered to the corresponding franchise.

Further, through the franchise manager screen, a list of warehoused products, a quantity of warehoused products, a list of shipped products, a quantity of shipped products, and a list of stored products in the corresponding franchise can be checked and managed. The franchise manager screen may further include a menu for providing the present status of unattended transactions caused by insufficient quantities in stock. Through the franchise manager screen, the franchise can grasp the present status of products warehoused in the franchise, the present status of products shipped from the franchise, and the present status of unattended transactions caused by insufficient quantities in stock.

The franchise manager screen may further include a menu for placing an order for extra products, in addition to the product ordered by the customer. Through the menu, the franchise can request the head office to deliver desirable products such that the stock quantity of products in the franchise can be secured.

Further, through the franchise manager screen, the franchise can make a request for the development of new product to the head office. The information on the request for the development of new product can be shared by all the franchises through a selection procedure.

When the central management server 30 receives a product delivery request through the franchise manager screen from the franchise terminal 20 at step S500, it gives a delivery instruction for the requested product by discriminating whether the product is directly delivered to the customer or is delivered to the franchise in charge of the customer.

As such, in order to deliver the products to the customer, sufficient quantities in stock should be maintained. However, among the products to be provided to the customer, some products may not be stored in the head office, but may be stored in the respective franchises. In this case, the following process is additionally required.

That is, when the product which is to be delivered to the customer or franchise is not stored in the head office, the central management server 30 gives a delivery instruction to a franchise having the corresponding product in stock. Therefore, the franchise storing the product which is not stored in the head office directly delivers the product to the customer or indirectly delivers the product through the head office, depending on the request from the head office. When the franchise having the product in stock is located in a position close to the customer, it is more effective that the franchise directly delivers the product to the customer.

Subsequently, payment is carried out by the customer or franchise. As for the payment, there are provided three types of payments such as a regular payment, a cash payment at the time of purchase, and a credit-card payment at the time of purchase.

When the payment of the customer is carried out through the cash payment or the regular payment, the central management server 30 checks if an adjusted amount is received from the franchise in charge of the customer. Then, the central management server 30 notices the result to the corresponding franchise terminal 20 (step 600). That is, the cash payment is carried out by such a method that the customer deposits money to the bank account of the franchise without a passbook while placing a product order. Therefore, the franchise in charge of the customer should calculate an adjusted amount from the amount received from the customer and then send the adjusted amount to the bank account of the head office. In the regular payment, the customer makes payment through a promised payment method on a monthly designated payment date. Even in this case, the franchise in charge of the customer is responsible for calculating an adjusted amount and then sending the adjusted amount to the head office providing the service.

When the customer makes payment by credit card, the central management server 30 receives the breakdown of the credit-card payment made by the customer from a credit card company and notices the breakdown of the credit-card payment and the resultant breakdown of an adjusted amount to the franchise terminal 20 (step S700). That is, when the credit-card payment is carried out by the customer, the corresponding amount is sent to the bank account of the head office, which means that collection of money is performed by the head office. Therefore, the adjusted amount, which is to be sent to the franchise, from the collected amount of money is sent to the bank account of the corresponding franchise from the head office. The breakdown of the adjusted amount is noticed to the franchise terminal 20.

Even when a local customer is positioned in a region where there is no franchise, the head office serves as a franchise in charge of the customer. Therefore, the customer directly makes transactions with the head office. Even in this case, the central management server 30 receives the breakdown of credit-card payment by the customer from a credit card company. That is, the head office directly receives the payment from the customer.

As described above, the franchise manages each customer, determines the delivery of a product ordered by the customer, and is responsible for the payment of the product ordered by the customer. Therefore, the head office carries out regular business and management education for the franchises side by side. For example, the head office carries out marketing and accounting education. Further, whenever a new ability with which the franchises should be equipped is required, the head office opens a franchise school so as to carry out additional education such that the respective franchises can be equipped with a sufficient ability as an operating body.

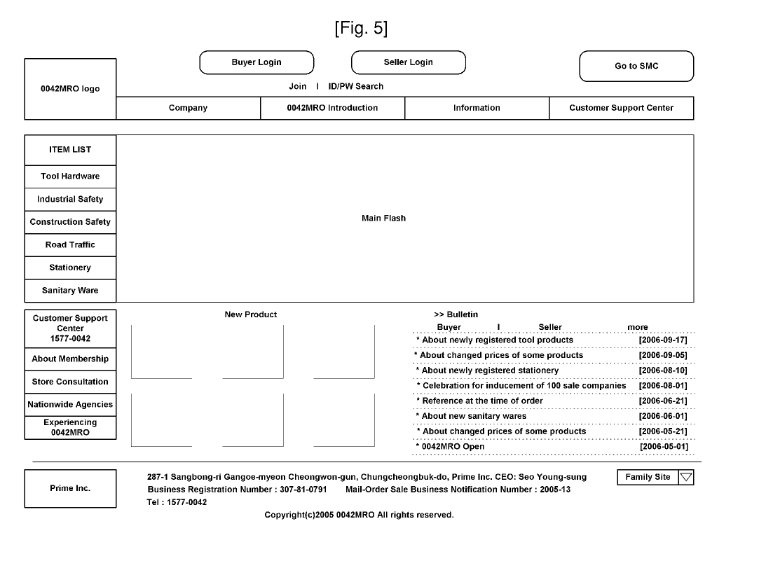

FIG. 5 is a diagram showing an initial screen in the method for online selling and managing unitedly by franchise's participation of partial responsibility according to the first embodiment of the invention.

As shown in FIG. 5, Buyer Login is a selection menu used when a customer who wants to purchase a product enters the customer interface screen, and Seller Login is a selection menu used when a franchise which has joined the membership enters the franchise manager screen. Further, Go to Supply Chain Management (SCM) is a selection menu for entering a central-management-server manager screen so as to manage the central management server 30.

In the left side of the screen, there are provided menus for selecting MRO materials, such as Tool Hardware, Industrial Safety, Road Traffic, Stationery, and Sanitary Ware. In addition, there are provided a menu for selecting a new item and a menu for checking a bulletin and contact information.

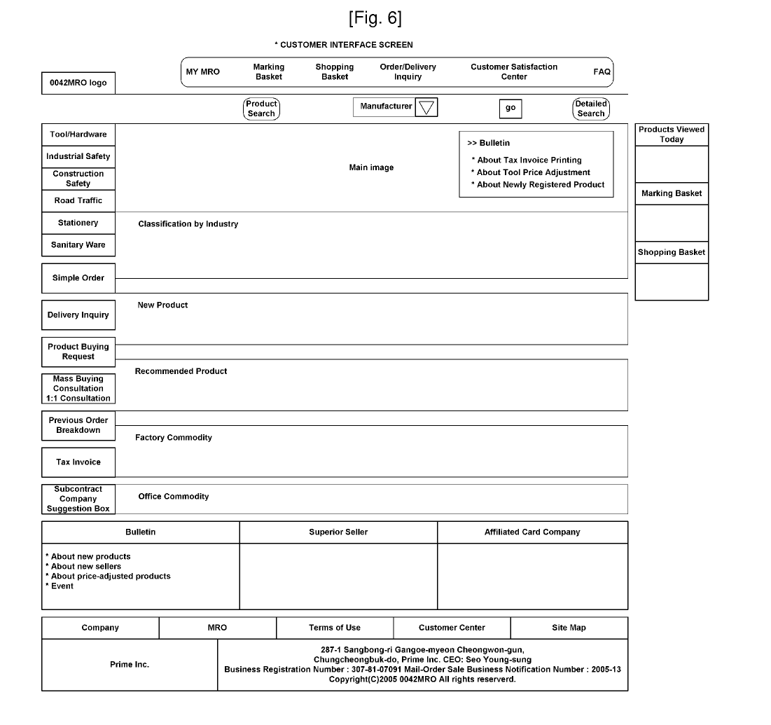

FIG. 6 is a diagram showing the customer interface screen in the method for online selling and managing unitedly by franchise's participation of partial responsibility according to the first embodiment of the invention.

Through My MRO menu, a customer can check/amend its own information and check its own purchase rating. Further, the customer can check the breakdown of transaction for each day, a payment date, a payment amount, whether the amount is paid or not, and the balance. In addition, the breakdown of previous orders can be searched for each day, each item, and each recipient.

The customer can select a desirable product in advance through a Marking Basket menu and place an order for the selected product through a Shopping Basket menu. At this time, when a window asking a payment method is popped up while the order sheet is filled, the customer can select a payment method such as credit card payment, cash payment, regular payment, or bill payment. Depending on the payment method, the price is varied.

Through Order/Delivery Inquiry menus, the customer can inquire the order and delivery and request cancellation, exchange, returning, and an after-sales service (AS). In addition, the customer can inquire the previous order and the breakdown of transaction (transaction amount and the like) for each day. Further, as the customer can input a purchase period (3, 6, and 9 months) to place an order for a product, an automatic order system for the ordered product can operate at every the purchase period.

Customer Satisfaction Center/FAQ provide questions, frequently asked when customers use the service, and the answers to the questions. Further, the menu guides the standards for the application of purchase rating, which is applied to a customer, and price rating for each category.

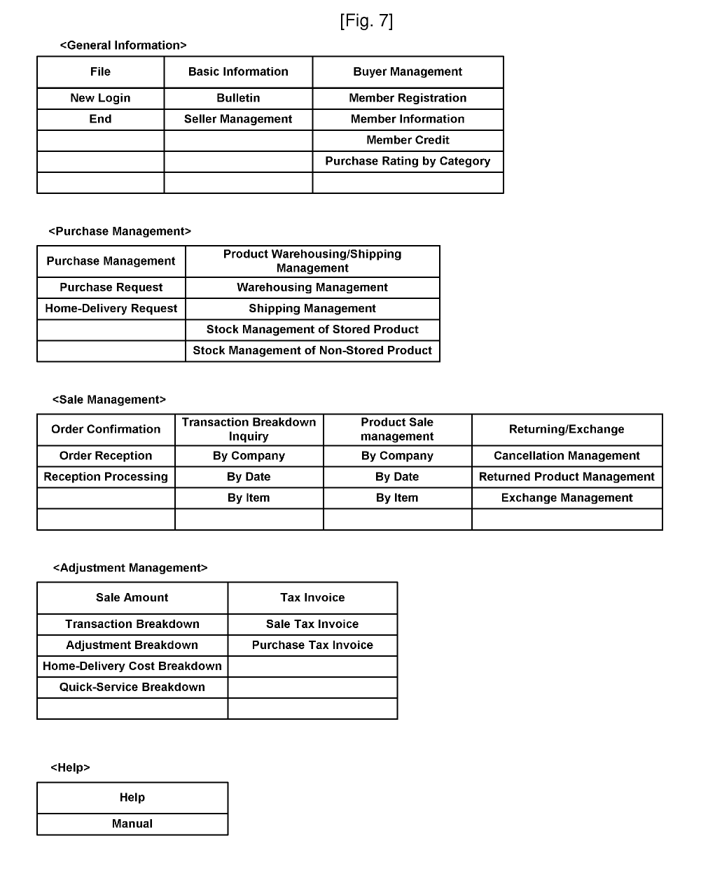

FIG. 7 is a diagram showing components of the franchise manager screen in the method for online selling and managing unitedly by franchise's participation of partial responsibility according to the first embodiment of the invention.

In <Purchase Management>, Product Warehousing and Shipping Management is a menu for checking a warehoused-product code, inputting a quantity of warehoused products, and checking stored items. Through the menu, only stored items are output on the screen such that the stock can be grasped. Further, when the stock is less than a predetermined quantity, it is represented by an unattended transaction. In addition, when a warehousing and shipping approval is made by barcode scan, the sales through this are directly reflected so that the present status of the stock is calculated and displayed.

In <Sale Management>, the delivery status of items, quantities, and amount for each day can be grasped through Transaction Breakdown Inquiry. Further, the product-sale status for each sale quantity, each amount, each period, and each customer on the basis of code, classification, product name, price, and quantity can be grasped through Product Sale Management.

In <Adjustment Management>, Tax Invoice is a menu for providing a monthly transaction amount for each customer. Further, a tax invoice can be managed and issued for each customer through the menu. In addition, the breakdown of purchase transaction of the head office can be checked, and a function of approving a tax invoice is provided.

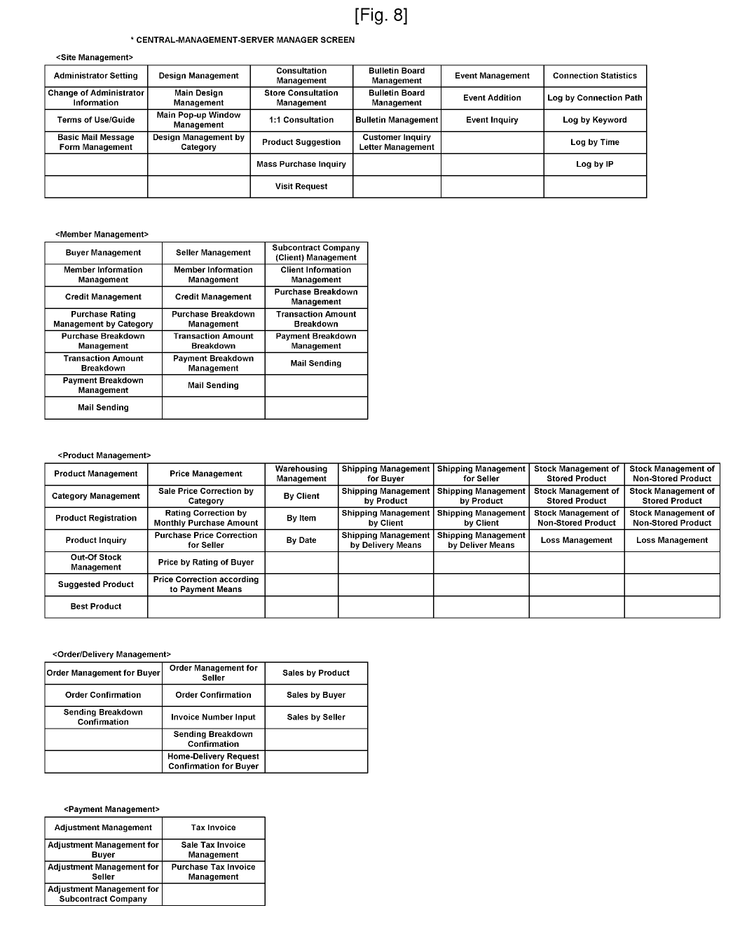

FIG. 8 is a diagram showing components of the central-management-server manager screen in the method for online selling and managing unitedly by franchise's participation of partial responsibility according to the first embodiment of the invention.

In <Member Management>, Buyer Management is a menu for managing customers who want to purchase products and provides a function of granting an unique code to a customer who has joined the membership. The unique code is constructed in the form of a combination of a local number and purchase rating (for example, AA/0000). Further, the menu provides a function of connecting a customer and a franchise existing in a region, to which the customer belongs, so as to designate the franchise as a franchise in charge of the customer. This case corresponds to a case where the customer directly joins the membership through the central management server 30 of the head office without a franchise. Further, the menu provides a function of managing the purchase rating of a customer for each category, transmitting the purchase rating to the customer through an Email, and managing the purchase breakdown, the transaction amount, and the payment breakdown.

Seller Management is a menu for managing franchises which have joined the service. The menu provides a function of managing the order breakdown, the home-delivery request breakdown, the purchase breakdown, the payment amount, and the payment breakdown of each franchise. Through the menu, setting can be performed in such a manner that, when a customer corresponding to the buyer logs in the central management server 30, the name of a franchise existing in a region, to which the customer belongs, is displayed.

In <Product Management>, Product Management is a menu for providing a function of setting a price depending on the purchase rating of each customer when a product is registered and collectively switching the price of the product depending on each classification.

Price Management is a menu for providing a function of differently registering the sale price of a product for each classification and managing a purchase price of each franchise and a price for the purchase rating of each customer. Further, through the menu, the price can be varied depending on which one of the credit-card payment, the cash payment, the regular payment, and the bill payment the payment method is.

Price Management is a menu for providing a function of differently registering the sale price of a product for each classification and managing a purchase price of each franchise and a price for the purchase rating of each customer. Further, through the menu, the price can be varied depending on which one of the credit-card payment, the cash payment, the regular payment, and the bill payment the payment method is.

In <Order/Delivery Management>, Buyer Order Management is a menu for providing a function of checking the correspondence status (direct delivery/home delivery) of a franchise in charge when a customer places an order. Hereinafter, a method for online selling and managing unitedly by franchise's participation of partial responsibility according to a second embodiment of the invention will be described.

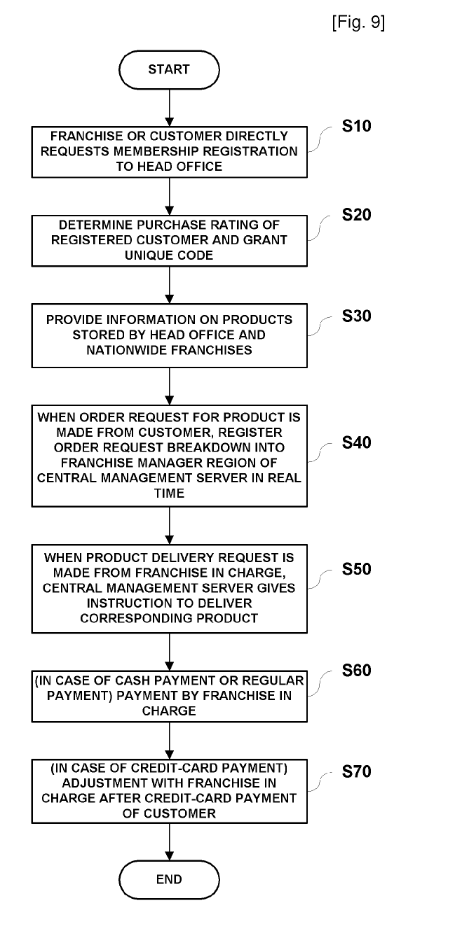

FIG. 9 is a flow chart for explaining a method for online selling and managing unitedly by franchise's participation of partial responsibility according to an embodiment of the invention according to the second embodiment of the invention.

As shown in FIG. 9, the central management server 30 receives predetermined information on a new customer from the franchise terminal 20 or the customer terminal 10 so as to receive a membership registration request (step S10). In this case, the franchise corresponds to a franchise which has already had a license contract with the head office on the offline. When a franchise makes a contract to participate in a business provided by the head office on the offline, the franchise is not a simply service subscriber, but serves as an operating body which manages the business with the head office. The franchise can carry on business in a region to which it belongs, with respect to a buyer which want to purchase products merchandised by a shopping mall. To use the service provided by the head office, the corresponding buyer must join the membership of the head office. The franchise, which is responsible for transaction with the buyer, first verifies the stability of the transaction and then makes request for membership registration such that the corresponding buyer can become a customer of the head office.

Further, the buyer can be directly connected to the central management server 30 of the head office so as to request the membership registration. In this case, since a franchise which manages the buyer does not exist, the head office designates a franchise in charge when the buyer is registered. In general, a franchise in charge of the region to which the buyer belongs is designated as the franchise in charge.

Subsequently, the central management server 30 determines the purchase rating of the customer, registers the customer as a member, and grants a unique code to the customer (step S20).

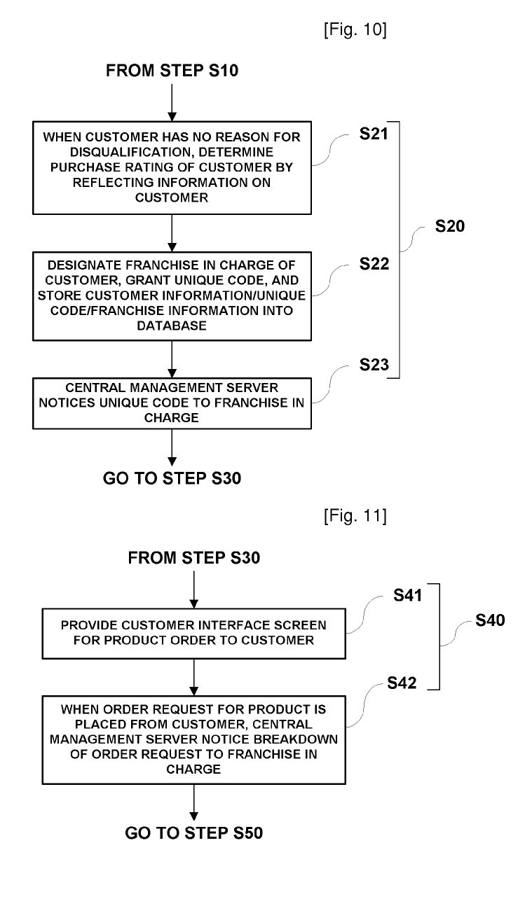

Referring to FIG. 10, the process of step S20 in the method for online selling and managing unitedly by franchise's participation of partial responsibility will be described in more detail.

As shown in FIG. 10, the central management server 30 verifies the customer who has request the membership registration. When the customer has no reason for disqualification, the central management server 30 registers the customer as a member and determines the purchase rating of the customer by reflecting predetermined information on the customer (S21). Here, the purchase rating is periodically updated by reflecting the credit, the transaction volume, and the integration degree for a single item of the customer, even after the purchase rating is set.

According to the invention, a discount rate is applied in accordance with the purchase rating of each customer such that the price can be discriminated. The standards for determining the purchase rating of each customer includes the credit, the transaction volume, and the integration degree for a single item of the customer. Therefore, when a customer joins the membership for the first time, a discount rate for product price is not applied. However, while the credit of the customer gradually increases and other transaction information is accumulated, the discount rate of the customer changes depending on a change in purchase rating. For example, when the credit of the customer decreases, the discount rate of the customer decreases. On the contrary, when the credit of the customer increases, the discount rate of the customer also increases. As such, the discount rate of the customer is determined depending on the purchase rating of the customer and is stored in the database 31. The update period for the credit, the transaction volume, and the integration degree for a single item of each customer can be arbitrarily set. Generally, they are updated every three months.

Next, the central management server 30 designates a franchise which is to be in charge of the customer who has joined the membership, grants a unique code to the customer, and stores the information and unique code of the customer and the information of the franchise in chare of the customer into the database (step S22). At this time, when the registration request is received by the franchise terminal 20, the customer is registered as a member who is to be managed by the franchise which has requested the membership registration. When the customer directly requests the membership registration, the customer is registered as a member who is to be managed by a franchise designated by the head office.

Subsequently, the central management server 30 notice the unique code, granted to the customer, to the franchise terminal 20 (step S23). Then, the franchise receiving the unique code of the customer individually informs the customer of the unique code, thereby notifying that the customer has been registered as a member of the head office. After that, the customer can start transactions using the service provided by the head office.

Next, as the customer terminal 10 requests connection, the central management server 30 performs user authentication. Then, the central management server 30 provides information on products, stored by the head office and nationwide franchises, to the customer terminal 10 (step S30). The product information includes the price of each product, and the price of each product is differentially provided to each customer, depending on the discount rate according to the purchase rate of the customer. That is, the product information provided to the customer connected to the central management server 30 is not limited to information on the products stored by the head office, but includes information on the overall products stored by all the franchises which have joined the service. At this time, when the credit of the customer decreases below a predetermined level because the payment of the customer is delayed, the central management server 30 does not provide the product information and the price of each product to the corresponding customer any more.

Next, when an order request for a product is made from the customer terminal 10, the central management server 30 registers the breakdown of the order request into a franchise manager region of the central management server 30 in real time (step S40). Referring to FIG. 11, the process of step S40 in the method for online selling and managing unitedly by franchise's participation of partial responsibility will be described in more detail.

First, the central management server 30 provides to the customer terminal 10 a customer interface screen through which a product order can be input (step S41).

At this time, when an order for a product is input from the customer terminal 10, the customer interface screen provides a menu for selecting a purchase period in such a manner that the order for the corresponding product is automatically placed at every the purchase period. Therefore, as the customer selects a predetermined purchase period (3, 6, or 12 months), an order for a product which should be periodically purchased can be placed in advance. Further, an order for various products which should be purchased at a monthly purchase period can be also placed in advance.

Further, the customer interface screen provides such menus that the customer can checks the breakdown of the previous order for each day and each product and the payment breakdown.

In addition, the customer interface screen provides a menu for inputting an order date for a product when the product is selected by an external input unit. When an advance-order button is activated by the external input unit, an input menu is displayed in a calendar form such that a necessary product can be checked and ordered for each day. That is, when the customer marks a product on the screen or clicks a daily or monthly advance-order button by using a mouse or the like, a calendar is created. Therefore, the customer can place an order for a necessary product, while checking the ordered product for each day at a look.

The customer interface screen displays the price of a product, which is automatically changed depending on the discount or extra rate of each franchise which sells the product. That is, when a discount or extra rate is applied to the product through such an event as an auction, group buying, or a stunning discount, the price of the product for each franchise is automatically changed and provided to the customer. At this time, when the customer selects a franchise, other information on the corresponding product is maintained without modification, and only the price of the product is automatically changed in accordance with the discount or extra rate of the franchise so as to be displayed on the customer interface screen.

The customer interface screen provides a menu for performing selection for an order after designating options of various products on one screen. In a case of purchase systems provided by various shopping malls, when a customer wants to buy a large number of products (such as clothes or shoes) for each size, the quantity of products for each size should be checked and then added to a shopping basket. For example, when three products are desired to be respectively purchased for five sizes, a shopping basket should be opened five times so as to select the products. That is, the products cannot be ordered at a time on one screen, but the shopping basket should be clicked a plurality of times. On the customer interface screen of the invention, however, various options such as a size, a quantity and the like can be tabulated in a detailed information window in such a manner that the customer can check the options at a look, and a necessary quantity of products for each size can be input in such a manner that the products can be added to a shopping basket at a time. Therefore, when the customer purchases products, the purchase time and the inconvenience can be reduced. Further, even when various standards are present depending on the size like drills of a tool, products having various sizes can be purchased at a time through the above-described method. Even in a case of set products, the customer can select necessary products and then construct a new set.

In addition, the customer interface screen displays the total price of the products, selected for an order, on a specific region within the screen in real time. That is, when the customer adds various products to the shopping basket, the total price of the products added to the shopping basket is displayed on the customer interface screen in real time. Therefore, the customer does not need to enter the shopping basket so as to check the total price of the selected products one at a time. Further, when products are purchased using a certificate of which the purchase limit is determined, the customer can check the total price displayed in real time such that the total price does not exceed the purchase limit. Therefore, it is possible to increase the purchase efficiency.

When a consultation request signal is received from the customer terminal 10, the central management server 30 connects the customer terminal 10 through wireless and wired communication to the call center 32 which provides consultation information. That is, the customer can request a consultation about all products, provided through the service of the head office, by using a call center service provided by the head office. Further, the customer can receive the detail descriptions of the product, about which the customer requested a consultation, and the information on the product.

Next, when an order request for a product is placed from the customer terminal 10, the central management server 30 registers the breakdown of the order request for the corresponding product into its management region of the franchise in charge in real time (step S42). At this time, the central management server 30 informs the head office or the franchise in charge, through an SMS or speaker, that the order request is received.

That is, after reviewing the product information provided by the central management server 30, the customer can place an order for a product through the central management server 30 of the head office connected through the communication network 40. At this time, products which can be ordered by the customer are not limited to the products stored by the head office, but include the overall products stored by all the franchises which have joined the service of the head office.

Subsequently, when a product delivery request is made from the franchise terminal 20, the central management server 30 gives an instruction to deliver a requested product (step S50). That is, the delivery instruction for the product which the customer has ordered is made through the franchise terminal 20 by the determination of the franchise which manages the customer.

At this time, when the franchise terminal 20 requests connection to the central management server 30 at steps S10 and S50, the central management server 30 performs user authentication and then provides a franchise manager screen. The franchise manager screen includes a menu, which provides information on each customer under management of the franchise, the present status of product orders of each customer, the present status of stored products of the head office, the present status of stored products of each franchise and the like, and a menu for selecting the type of product delivery by discriminating whether the ordered product is directly delivered to the customer from the head office or is delivered to the corresponding franchise.

That is, the final decision for delivering the ordered product to the customer is made by the selection of the franchise in charge of the corresponding customer. In this case, when the franchise does not have the product in stock, the franchise can select the type of the product delivery through the franchise manager screen such that the product can be directly delivered to the customer from the head office. When the franchise has the product in stock, the franchise can directly deliver the product to the customer, which is optional. Therefore, the delivery can be more effectively achieved depending on the selection of the franchise. If necessary, the franchise may first receive the product and then deliver the product to the customer. In this case, the franchise can select the type of the product delivery such that the product is first delivered to the corresponding franchise.

The franchise manager screen provides a function of adding up sales of the corresponding franchise and grasping whether or not there are products to be delivered. Further, the franchise manager screen provides an accounting and stock management function. That is, through the franchise manager screen, a list of warehoused products, a quantity of warehoused products, a list of shipped products, a quantity of shipped products, and a list of stored products in the franchise can be checked and managed. The franchise manager screen may further include a menu for providing the present status of unattended transactions caused by insufficient quantities in stock. Through the franchise manager screen, the franchise can grasp the present status of products warehoused in the franchise, the present status of products shipped from the franchise, and the present status of unattended transactions caused by insufficient quantities in stock.

The franchise manager screen provides a function of displaying the image of a product on a pop-up window when the product is selected from a product list by an external input unit. In an existing manager system, only a product list was provided, but the image of each product could not be checked directly. Therefore, it was not easy to grasp what the product is like. Since it is considered that a manager sufficiently knows information on each product, the system was implemented in such a manner. In the invention, however, tens of thousands of kinds of products are managed. Therefore, it is not easy for a manager to grasp specific information on all the products. Therefore, the franchise manager screen and the manager menu of the head office provide a function of displaying the image of a product on a pop-up window when the name of the product on the screen is clicked by an input unit such as a mouse or the like.

The franchise manager screen may further include a menu for placing an order for extra products, in addition to a product ordered by a customer. Through the menu, the franchise can request the head office to deliver desirable products such that the stock quantity of products in the franchise can be secured.

Further, through the franchise manager screen, the franchise can make a request for the development of new product to the head office. The information on the request for the development of new product can be shared by all the franchises through a selection procedure.

When the central management server 30 receives a product delivery request through the franchise manager screen from the franchise terminal 20 at step S50, it gives a delivery instruction for the requested product by discriminating whether the product is directly delivered to the customer or is delivered to the franchise in charge of the customer.

As such, in order to deliver the product to the customer, sufficient quantities in stock should be maintained. However, among the products to be provided to the customer, some products may not be stored in the head office, but may be stored in the respective franchises. In this case, the following process is additionally required.

That is, when the product which is to be delivered to the customer or franchise is not stored in the head office, the central management server 30 gives a product delivery instruction to a franchise having the corresponding product in stock. Therefore, the franchise storing the product which is not stored in the head office directly delivers the product to the customer or indirectly delivers the product through the head office, depending on the request from the head office. When the franchise having the product in stock is located in a position close to the customer, it is more effective that the franchise directly delivers the product to the customer.

Subsequently, payment is carried out by the customer or franchise. As for the payment, there are provided three types of payments such as a regular payment, a cash payment at the time of purchase, a credit-card payment at the time of purchase, and a cash payment at the time of receiving a product.

When the payment of the customer is carried out through the cash payment or the regular payment, the central management server 30 checks if an adjusted amount is received from the franchise in charge of the customer. Then, the central management server 30 notices the result to the corresponding franchise terminal 20 (step 60). That is, the cash payment is carried out by such a method that the customer deposits money into the bank account of the franchise without a passbook while placing a product order. Therefore, the franchise in charge of the customer should calculate an adjusted amount from the amount received from the customer and then send the adjusted amount to the bank account of the head office. In the regular payment, the customer makes payment through a promised payment method on a monthly designated payment date. Even in this case, the franchise in charge of the customer is responsible for calculating an adjusted amount and then sending the adjusted amount to the head office providing the service.

When the customer makes payment by credit card, the central management server 30 receives the breakdown of the credit-card payment made by the customer from a credit card company and notices the breakdown of the credit-card payment and the resultant breakdown of an adjusted amount to the franchise terminal 20 (step S70). That is, when the credit-card payment is carried out by the customer, the corresponding amount is sent to the bank account of the head office, which means that collection of money is performed by the head office. Therefore, the adjusted amount, which is to be sent to the franchise, from the collected amount of money is sent to the bank account of the corresponding franchise from the head office. The breakdown of the adjusted amount is noticed to the franchise terminal 20.

Even when a local customer is located in a region where there is no franchise, the head office serves as a franchise in charge of the customer. Therefore, the customer directly makes transactions with the head office. Even in this case, the central management server 30 receives the breakdown of credit-card payment by the customer from a credit card company. That is, the head office directly receives the payment from the customer.

As described above, the franchise manages each customer, determines the delivery of a product ordered by the customer, and is responsible for the payment of the product ordered by the customer. Therefore, the head office carries out regular business and management education for the franchises side by side. For example, the head office carries out marketing and accounting education. Further, whenever a new ability with which the franchises should be equipped is required, the head office opens a franchise school so as to carry out additional education such that the respective franchises can be equipped with a sufficient ability as an operating body.

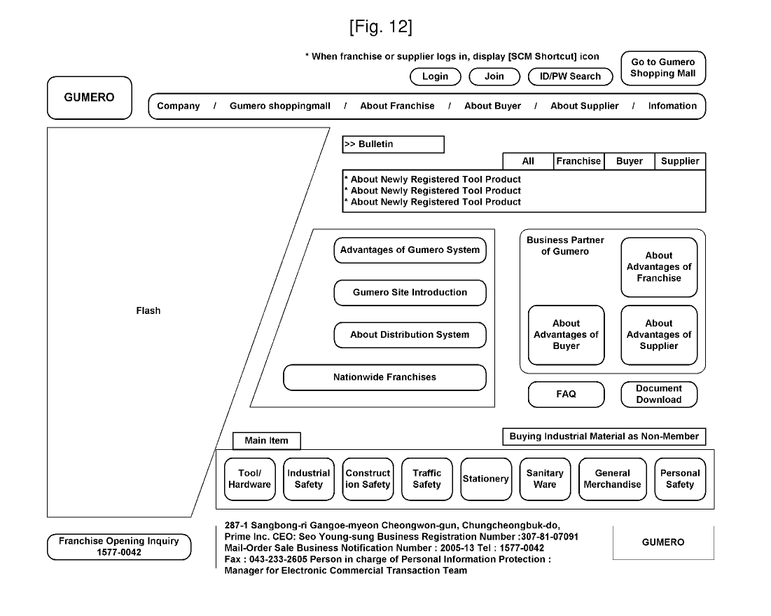

FIG. 12 is a diagram showing an initial screen in the method for online selling and managing unitedly by franchise's participation of partial responsibility according to the second embodiment of the invention.

As shown in FIG. 12, the image of a company and a flash image, by which the character of the site can be grasped at a look, are displayed on the left side of the screen. Further, the respective bulletins for a franchise which sells products, a buyer which purchases products, and a supplier which supplies products are displayed on the right side of the screen. When each of the franchise, the buyer, and the supplier logs in the site, a purchase and management screen configured for each of the franchise, the buyer, and the supplier is provided.

In the lower side of the screen, main items which can be purchased through the shopping mall are displayed. On the upper right side of the screen, a shopping mall button for purchasing the corresponding products is provided.

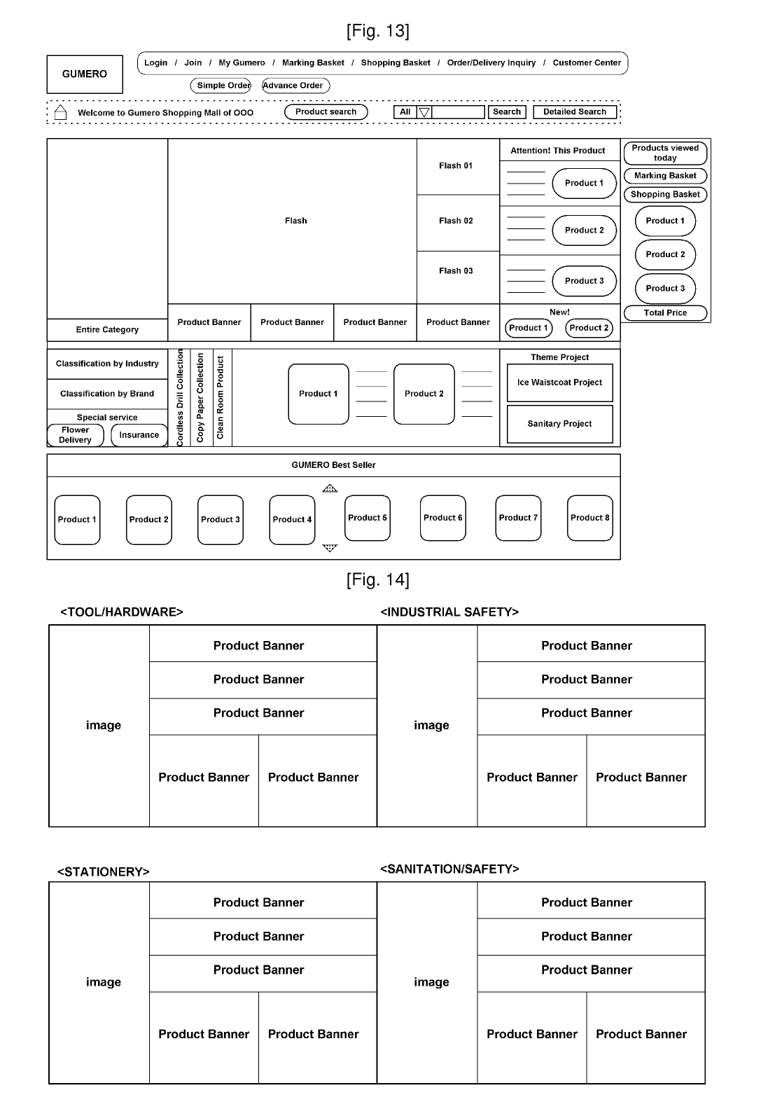

FIG. 13 is a diagram showing the customer interface screen in the method for online selling and managing unitedly by franchise's participation of partial responsibility according to the second embodiment of the invention.

As shown in FIG. 13, various product lists by category are arranged in the left upper side of the screen. Further, product banners by which the images and information of representative products can be grasped are arranged.

Further, a shopping basket screen, which displays a list of products selected by a customer and the total price of the products in real time, is displayed on the right upper side.

FIG. 14 is a diagram showing a portion of the customer interface screen in the method for online selling and managing unitedly by franchise's participation of partial responsibility according to the second embodiment of the invention.

As shown in FIG. 14, a product information providing menu for each product list is shown, which provides more specific product information on the product list shown in FIG. 13. The menu is configured to display various product banners and the images of products.

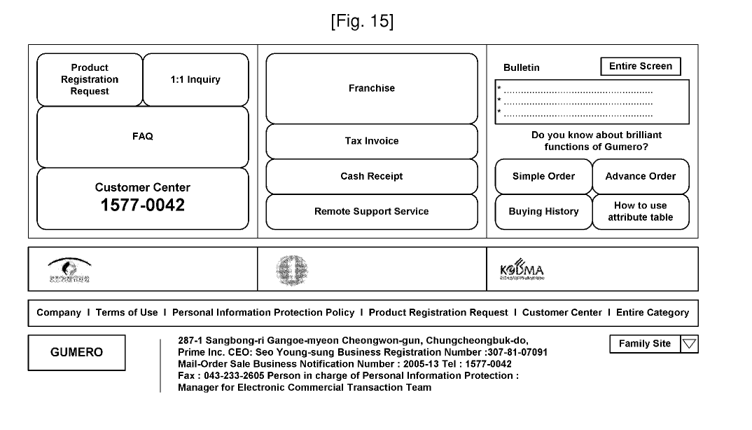

FIG. 15 is a diagram showing a portion of the customer interface screen in the method for online selling and managing unitedly by franchise's participation of partial responsibility according to the second embodiment of the invention.

As shown in FIG. 15, the screen provides various product order menus such as Simple Order, Advance Order, Purchase History and the like. Further, the screen provides menus for inquiry about the shopping mall and how to use the shopping mall. In addition, the screen provides a menu for issuing various accounts and receipts.

While the present invention has been described with reference to exemplary embodiments thereof, it will be understood by those skilled in the art that various changes and modifications in form and detail may be made therein without departing from the scope of the present invention as defined by the following claims.

1. A method for online selling and managing unitedly by franchise's participation of partial responsibility, the method comprising the steps of:
at a central management server, receiving predetermined information on a new customer from a franchise terminal or customer terminal so as to receive a membership registration request (step 100);
at the central management server, determining the purchase rating of the customer, registering the customer as a member, and granting a unique code to the customer (step 200);
at the central management server, performing user authentication as the customer terminal requests connection, and then providing information on products, stored by a head office and nationwide franchises, to the customer terminal (step 300);
at the central management server, when an order request for a product is made from the customer terminal, noticing the breakdown of the order request to a franchise in charge of the customer by using a wired and wireless communication network (step 400); and
at the central management server, when a product delivery request is made from the franchise terminal, giving an instruction to deliver the requested product (step 500).

2. The method according to claim 1, wherein the purchase rating is periodically updated by reflecting the credit, the transaction volume, and the integration degree for a single item of the customer.

3. The method according to claim 2, wherein the product information includes the price of the product, and the price of the product is differentially determined for each customer, depending on a discount rate according to the purchase rating of the customer.

4. The method according to claim 3 further comprising the step of: at the central management server, when the payment of the customer is performed through cash payment or regular payment, checking if an adjusted amount is received from the franchise in charge of the customer, and noticing the result to the franchise terminal (step 600).

5. The method according to claim 3 further comprising the step of: at the central management server, when the payment of the customer is performed through credit-card payment, receiving the breakdown of the credit-card payment by the customer from a credit card company, and noticing the breakdown of the credit-card payment and the adjusted breakdown of the payment to the franchise terminal (step 700).

6. The method according to claim 1, wherein step 200 includes:
at the central management server, verifying the customer who has requested the membership registration, registering the customer as a member when the customer has no reason for disqualification, and determining the purchase rating of the customer by reflecting the received predetermined information on the customer (step 210);
at the central management server, designating a franchise in charge of the registered customer, granting a unique code to the customer, and storing the information on the customer, the unique code, and information on the franchise in charge of the customer into a database (step 220); and
at the central management server, noticing the unique code, granted to the customer, to the franchise terminal of the franchise in charge of the customer (step 230).

7. The method according to claim 1, wherein step 400 includes:
at the central management server, providing a customer interface screen, through which a product order is placed, to the customer terminal (step 410); and
at the central management server, when an order request for a product is made from the customer terminal, noticing the breakdown of the order request to the franchise in charge through the wired and wireless communication network (step 420).

8. The method according to claim 7, wherein the customer interface screen includes a menu for inputting an order request for a product and a purchase period such that the order request is automatically made at every the purchase period and a menu for checking the breakdown of the previous order for each day and each item and the payment breakdown.

9. The method according to claim 7, wherein as for the wireless and wired communication, an email, a mobile-phone text message, an automatic phone using Computer Telephony Integration (CTI) and the like are used.

10. The method according to claim 1, wherein when the franchise terminal requests connection to the central management server at steps 100 and 500, the central management server performs user authentication and then provides a franchise manager screen to the franchise terminal, the franchise manager screen including a menu for providing information on each customer under management of the franchise, the present status of product order from each customer, the present status of products stored by the head office, the present status of products stored by each franchise and the like, and a menu for selecting the type of product delivery by discriminating whether the ordered product is directly delivered to the customer from the head office or is delivered to the corresponding franchise.

11. The method according to claim 10, wherein when a product delivery request is made from the franchise terminal through the franchise manager terminal at step 500, the central management server gives an instruction to deliver a requested product by discriminating whether the product is delivered to the customer or the franchise in charge.

12. The method according to claim 10, wherein the franchise manager screen includes a menu for checking and managing a list of warehoused products, a quantity of warehoused products, a list of shipped products, a quantity of shipped products, and a list of stored products in the corresponding franchise and a menu for providing the present status of unattended transactions caused by insufficient quantities in stock.

13. The method according to claim 11, wherein when the head office does not store a product which is to be delivered to the customer or the franchise, the central management server makes a product delivery request to a franchise, which stores the corresponding product, among the nationwide franchises.

14. A method for online selling and managing unitedly by franchise's participation of partial responsibility, the method comprising the steps of:
(a) at a central management server, receiving predetermined information on a new customer from a franchise terminal so as to receive a membership registration request;
(b) at the central management server, designating the franchise, which has requested membership registration, as a franchise in charge of the customer, registering the customer as a member with a predetermined purchase rating, and granting a unique code to the customer;
(c) at the central management server, performing user authentication as a customer terminal requests connection, and then providing information on products, stored by a head office and nationwide franchises, to the customer terminal;
(d) at the central management server, when an order request for a product is made from the customer terminal, registering the breakdown of the order request into a franchise manager region of the central management server in real time;
(e) at the franchise terminal connected to the central management server, checking the breakdown of the order request through a franchise manager screen so as to make a delivery request for the product;
(f) at the central management server, giving an instruction to deliver the ordered product; and
(g) at the customer terminal, making payment for the ordered product,
wherein the delivery request at step (e) is made to a delivery department of the franchise when the franchise has the ordered product in stock, or to the head office when the franchise does not have the ordered product in stock or should secure the stock of a specific product, the delivering at step (f) is divided into the delivering to the customer and the delivering to the franchise, the payment by the customer at step (g) is carried out for the franchise in charge of the customer, and the franchise is responsible for the payment of the product for which the franchise made a delivery request to the head office at step (e).

15. The method according to claim 14, wherein the purchase rating is periodically updated by reflecting the credit, the transaction volume, and the integration degree for a single item of the customer.

16. The method according to claim 15, wherein the product information includes the price of the product, and the price of the product is differentially determined for each customer, depending on a discount rate according to the purchase rating of the customer.

17. The method according to claim 16 further comprising the step of: at the central management server, when the payment of the customer is performed through cash payment or regular payment, checking if an adjusted amount is received from the franchise in charge of the customer, and noticing the result to the franchise terminal.

18. The method according to claim 16 further comprising the step of: at the central management server, when the payment of the customer is performed through credit-card payment, receiving the breakdown of the credit-card payment by the customer from a credit card company, and noticing the breakdown of the credit-card payment and the adjusted breakdown of the payment to the franchise terminal.

19. The method according to claim 16, wherein step (b) includes:
(b-1) at the central management server, verifying the customer who has requested the membership registration, registering the customer as a member when the customer has no reason for disqualification, and determining the purchase rating of the customer by reflecting the received predetermined information on the customer;
(b-2) at the central management server, designating a franchise in charge of the registered customer, granting a unique code to the customer, and storing the information on the customer, the unique code, and information on the franchise in charge of the customer into a database; and
(b-3) at the central management server, noticing the unique code, granted to the customer, to the franchise terminal of the franchise in charge of the customer.

20. The method according to claim 14, wherein step (d) includes:
(d-1) at the central management server, providing a customer interface screen, through which a product order is placed, to the customer terminal; and (d-2) at the central management server, when a order request for a product is made from the customer terminal, registering the breakdown of the order request into the franchise manager region of the central management server in real time.

21. The method according to claim 20, wherein the customer interface screen includes a menu for inputting an order request for a product and a purchase period such that the order request is automatically made at every the purchase period and a menu for checking the breakdown of the previous order for each day and each item and the payment breakdown.

22. The method according to claim 20, wherein the customer interface screen provides a menu for inputting an order date for a product when the product is selected by an external input unit.

23. The method according to claim 20, wherein the customer interface screen provides a menu for inputting an order date for a product when the product is selected by an external input unit.

24. The method according to claim 20, wherein the customer interface screen displays the price of each product which is automatically varied depending on a discount or extra rate which is separately set for each franchise selling the product.

25. The method according to claim 20, wherein the customer interface screen provides a menu for designating options of various products on one screen and then performing selection for an order.

26. The method according to claim 20, wherein the customer interface screen displays the total price of products, selected for an order, on a specific region within the customer interface screen in real time.

27. The method according to claim 14, wherein when the franchise terminal requests connection to the central management server at steps (a) and (e), the central management server performs user authentication and then provides a franchise manager screen to the franchise terminal, the franchise manager screen including a menu for providing information on each customer under management of the franchise, the present status of product order from each customer, the present status of products stored by the head office, the present status of products stored by each franchise and the like, and a menu for selecting the type of product delivery by discriminating whether the ordered product is directly delivered to the customer from the head office or is delivered to the corresponding franchise.

28. The method according to claim 27, wherein when a product delivery request is received from the franchise terminal through the franchise manager terminal at step (e), the central management server gives an instruction to deliver the requested product by discriminating whether the product is directly delivered to the customer or is delivered to the franchise in charge.

29. The method according to claim 27, wherein the franchise manager screen includes a menu for checking and managing a list of warehoused products, a quantity of warehoused products, a list of shipped products, a quantity of shipped products, and a list of stored products in the corresponding franchise and a menu for providing the present status of unattended transactions caused by insufficient quantities in stock.

30. The method according to claim 27, wherein the franchise manager screen displays the image of a specific product on a pop-up window, when the product is selected from a product list by the external input unit.

31. The method according to claim 27, wherein when the head office does not store the ordered product at step (f), the central management server makes a product delivery request to a franchise, which stores the corresponding product, among the nationwide franchises.
